(19) United States
(12) Patent Application Publication
(10) Pub. No.: US 2006/0002031 A1
(43) Pub. Date: Jan. 5, 2006

(54) Magnetic sensing device and method of forming the same

(75) Inventor: Shigeru Shoji, Tokyo (JP)

Correspondence Address: OLIFF & BERRIDGE, PLC, P.O. BOX 19928, ALEXANDRIA, VA, 22320, US

(73) Assignee: TDK CORPORATION, Tokyo (JP)

(21) Appl. No.: 11/157,915

(22) Filed: Jun. 22, 2005

(30) Foreign Application Priority Data
Jun. 30, 2004 (JP) 2004-193735

(51) Int. Cl. G11B 5/127

(52) U.S. Cl. 360/313; 324/200; 324/244; 360/324.1

(57) ABSTRACT

The present invention provides a magnetic sensing device capable of stably sensing a signal magnetic field with high sensitivity by suppressing occurrence of hysteresis to reduce 1/f noise. A magnetic sensing device has a stacked body including a pinned layer having a magnetization direction pinned to a predetermined direction (Y direction), a free layer having a magnetization direction which changes according to an external magnetic field and, when the external magnetic field is zero, becomes parallel to the magnetization direction of the pinned layer, and an intermediate layer sandwiched between the pinned layer and the free layer. The thickness of the intermediate layer is set so that an exchange bias magnetic field becomes positive. Consequently, the magnetization directions are stabilized. When read current is passed in a state where an external magnetic field is applied in a direction orthogonal to the magnetization direction of the pinned layer, occurrence of hysteresis in the relation between a change in the external magnetic field and a resistance change can be suppressed. As a result, 1/f noise is suppressed and a signal magnetic field can be stably sensed with high sensitivity.

### BACKGROUND OF THE INVENTION

1. Field of the Invention

The present invention relates to a magnetic sensing device capable of sensing a change in a signal magnetic field at high sensitivity and a method of forming the same.

2. Description of the Related Art

Generally, a magnetic recording/reproducing apparatus for writing/reading magnetic information to/from a recording medium such as a hard disk has a thin film magnetic head including a magnetic recording head and a magnetic reproducing head. The reproducing head has a giant magnet-resistive effect element (hereinbelow, GMR element) executing reproduction of a digital signal as magnetic information by using so-called giant magnet-resistive effect.

The GMR element used for a thin film magnetic head generally has a spin valve structure as shown in FIG. 17. Concretely, the GMR element is a stacked body 120 including a pinned layer 121 whose magnetization direction is pinned in a predetermined direction, a free layer 123 whose magnetization direction changes according to an external magnetic field, and an intermediate layer 122 sandwiched between the pinned layer 121 and the free layer 123 (refer to, for example, U.S. Pat. Nos. 5,159,513 and 5,206,590). Each of the top face (the face on the side opposite to the intermediate layer 122) of the pinned layer 121 and the under face (the face on the side opposite to the intermediate layer 122) of the free layer 123 is protected with a not-shown protection layer. In the pinned layer 121, specifically, as shown in FIG. 18 for example, a magnetization pinned film 124 and an antiferromagnetic film 125 are stacked in order from the side of the intermediate layer 122. The magnetization pinned film 124 may be a single layer or a synthetic layer in which a ferromagnetic layer 141, an exchange coupling film 142, and a ferromagnetic layer 143 are formed in order from the side of the intermediate layer 122 as shown in FIG. 19. The free layer 123 may be a single layer or may have a configuration that, for example as shown in FIG. 20, a ferromagnetic film 131, an intermediate film 132, and a ferromagnetic film 133 are formed in order from the side of the intermediate layer 122 and the ferromagnetic films 131 and 133 are exchange-coupled. Such a spin valve structure is formed by a method of sputtering, vacuum deposition, or the like.

The materials and the like of the pinned layer and the free layer in the GMR element used for a thin film magnetic head are disclosed in, for example, U.S. Pat. No. 5,549,978. The material of the intermediate layer sandwiched by the pinned layer and the free layer is generally, for example, copper (Cu). A GMR element capable of using so-called tunnel effect obtained by making a very thin intermediate layer (tunnel barrier layer) of an insulating material such as aluminum oxide (Al₂O₃) in place of copper was also developed.

In the GMR element used for a thin film magnetic head, the magnetization direction of the free layer freely changes according to a signal magnetic field generated from a magnetic recording medium. At the time of reading magnetic information recorded on a magnetic recording medium, for example, read current is passed along a stacked-body in-plane direction to the GMR element. At this time, the read current displays an electric resistance value which varies according to the state of the magnetization direction of the free layer. Consequently, a change in the signal magnetic field generated from the recording medium is detected as a change in electric resistance.

This phenomenon will be described in more detail by referring to FIGS. 21A and 21B. FIGS. 21A and 21B show the relation between the magnetization directions of the pinned layer 121 and free layer 123 and the electric resistance of the read current in the spin valve structure. The magnetization direction of the pinned layer 121 is indicated by reference numeral J121 and that of the free layer 123 is indicated by reference numeral J123. FIG. 21A shows a state where the magnetization directions of the pinned layer 121 and the free layer 123 are parallel to each other, and FIG. 21B shows a state where the magnetization directions of the pinned layer 121 and the free layer 123 are anti-parallel to each other. In FIGS. 21A and 21B, in the case of passing read current in the stacked-body in-plane direction, it is estimated that the read current flows mainly in the intermediate layer 122 having high electric conductivity. Electrons “e” flowing in the intermediate layer 122 are subjected to either scattering (which contributes to increase in electric resistance) or mirror-reflection (which does not contribute to increase in electric resistance) in an interface K123 with the free layer 123 and an interface K121 with the pinned layer 121. In the case where the magnetization directions J121 and J123 are parallel to each other as shown in FIG. 21A, the electrons “e” having spins Se parallel to the directions are not so scattered by the interfaces K121 and K123 and display relatively low electric resistance. However, in the case where the magnetization directions J121 and J123 are anti-parallel to each other as shown in FIG. 21B, the electrons “e” are easily scattered by the interface K121 or K123 and relatively high electric resistance is displayed. FIG. 21B shows a state where the electron “e” having the spin Se to the right side of the drawing sheet is scattered by the interface K123 with the free layer 123. As described above, in the GMR element having the spin valve structure, electric resistance of the read current changes according to the angle of the magnetization direction J123 with respect to the magnetization direction J121. Since the magnetization direction J123 is determined by the external magnetic field, as a result, a change in the signal magnetic field from a recording medium can be detected as a resistance change in the read current.

Usually, a GMR element having the spin valve structure is constructed so that the magnetization direction of the free film (free layer) and that of the magnetization pinned film (pinned layer) are orthogonal to each other when an external magnetic field is not applied (H=0). The direction of the easy axis of magnetization of the free layer is set to be the same as the magnetization direction of the pinned layer. The GMR element with such a configuration is disposed so that the magnetization direction of the pinned layer is parallel to the direction of application of the external magnetic field. In such a manner, the center point of an operation range of the magnetization direction in the free layer can be set to the state where no external magnetic field is applied (H=0). That is, the state where the external magnetic field is zero can be set to the center of an amplitude of electric resistance which can be changed by a change in the external magnetic field. Consequently, it is unnecessary to apply a bias magnetic field to the GMR element.

The above will be concretely described with reference to FIGS. 22A to 22C and FIG. 23. FIGS. 22A to 22C show a state where magnetic information on a recording medium is read by a thin film magnetic head on which the GMR element is mounted in a general hard disk drive. As shown in FIG. 22A, the GMR element 120 is disposed close to the recording face 110 of a recording medium so that the magnetization direction J121 of the pinned layer 121 is the +Y direction which is the direction (Y axis direction) orthogonal to the recording face 110 of the recording medium and the magnetization direction J123 of the free layer 123 is the +X direction which is the direction (X axis direction) of the track width of the recording medium. It is assumed that there is no influence of the signal magnetic field from the recording medium at this point. When the hard disk drive is driven and, for example as shown in FIG. 22B, a magnetic field in a signal magnetic filed direction J110 in the −Y direction is generated from a recording medium, the magnetization direction J123 becomes the −Y direction which is the opposite to the magnetization direction J121. Therefore, the resistance value of the read current increases as described with reference to FIG. 23. On the other hand, for example, in the case where a signal magnetic field in the signal magnetic field direction J110 from the recording medium is in the +Y direction as shown in FIG. 22C, the magnetization direction J123 becomes the +Y direction which is the same as the magnetization direction J121. Therefore, the resistance value of the read current decreases. By making, for example, the state of FIG. 22B associated with “0” and making the state of FIG. 22C associated with “1” by using the resistance change, the signal magnetic field can be detected as binary information. As obvious from FIGS. 22A to 22C, the center of the amplitude of the magnetization direction J123 corresponds to the state of FIG. 22A (H=0). FIG. 23 shows the relation between the external magnetic field (signal magnetic field) H and electric resistance R in the GMR element 120. In FIG. 23, the external magnetic field in the −Y direction in FIGS. 22A to 22C is set as H>0 and that in the +Y direction is set as H<0. As shown in FIG. 23, as the intensity of the signal magnetic field in the −Y direction increases, the electric resistance R increases and is saturated in the end. As the intensity of the signal magnetic field in the +Y direction increases, the electric resistance R decreases and is saturated in the end. In such a manner, the electric resistance R changes around the state where the external magnetic field H is zero as a center. Therefore, the GMR element having the spin-valve structure in which the magnetization direction of the free layer and that of the pinned layer are orthogonal to each other at the zero magnetic field does not have to have bias applying means, so that it is generally applied to read magnetic information recorded on a hard disk, a flexible disk, a magnetic tape, or the like. Orthogonalization of the magnetization directions is realized by performing, mainly, a regularization heat treatment process which determines the magnetization direction of the pinned layer and an orthogonalization heat treatment process which follows the regularization heat treatment process and determines the magnetization direction of the free layer.

FIGS. 24A to 24C show the outline of a process of forming the stacked body 120 in which the magnetization direction J121 of the pinned layer 121 and the magnetization direction J123 of the free layer 123 are orthogonal to each other. Concretely, first, while applying a magnetic field H101 in the +X direction for example, the free layer 123 is formed by sputtering or the like and the direction AE123 of the easy axis of magnetization is pinned (refer to FIG. 24A) and, after that, the intermediate layer 122 and the pinned layer 121 are sequentially formed. As shown in FIG. 24B, while applying a magnetic field H102 in the direction (for example, +Y direction) orthogonal to the magnetic field H101, annealing process is performed at a predetermined temperature (regularization heat treatment process). By the process, the magnetization directions J121 and J123 are aligned in the direction of the magnetic field H102. Further, as shown in FIG. 24C, while applying a magnetic field H103 of relatively low intensity in the direction (+X direction) orthogonal to the magnetic field H102, annealing process is performed at a rather low temperature (orthogonalization heat treatment process). By the processes, while the magnetization direction J121 is pinned, only the magnetization direction J123 is directed again to the +X direction. As a result, the stacked body 120 in which the magnetization directions J121 and J123 are orthogonal to each other is completed.

The GMR element having the spin valve structure subjected to the orthogonalization heat process is effective to obtain a high dynamic range as well as high output and is suitable for reproducing a magnetization inverted signal which is digitally recorded. Before such a GMR element is used, an AMR element using anisotropic magnet-resistive (AMR) effect was generally used as means for reproducing a digital recording signal. Hitherto, the AMR element is used as means for reproducing not only a digital signal but also an analog signal (refer to, for example, Translated National Publication of Paten Application No. Hei 9-508214). Recently, application of the GMR element as means for reproducing an analog signal in a manner similar to the AMR element has been being examined (refer to, for example, Japanese Patent Laid-Open No. 2001-358378).

In the case of applying the GMR element as the means for reproducing an analog signal, however, hysteresis of an output characteristic becomes a problem as described below. When the free layer 123 in the GMR element subjected to the orthogonalization heat treatment is observed from a microscopic viewpoint, as schematically shown in FIG. 25, it is found that spin directions 123S in magnetic domains 123D partitioned by magnetic walls 123W are various and are not aligned in a predetermined direction. Such variations in the spin direction 123S appear as hysteresis characteristic in the relation between the external magnetic field H and the electric resistance R when read current is passed in a state where an external magnetic field H is applied in a direction almost orthogonal to the spin direction 123S. FIG. 23 corresponds to an ideal state in which the spin directions in the magnetic domains in the free layer are perfectly aligned in one direction. In reality, however, the spin direction 123S varies in the GMR element subjected to the orthogonalization heat treatment, so that a resistance change curve when the magnetic field H is applied in the direction orthogonal to the spin direction 123S is expressed as HC1 as shown in FIG. 26, and hysteresis occurs at the zero magnetic field. The occurrence of the hysteresis appears as 1/f noise in a relatively low frequency band as shown in FIG. 27. The 1/f noise occurs at a frequency “f” or lower and becomes more conspicuous as the frequency “f” becomes lower. FIG. 27 shows a state where the influence of a 1/f noise component N2 on “noise voltage density” increases as compared with a white noise component N1 as the frequency “f” becomes lower. Increase in the 1/f noise is unpreferable since it is a big factor of deteriorating the reliability of the whole system.

In Japanese Patent Laid-Open No. 2001-358378, by disposing a plurality of soft magnetic bodies each having a linear or rectangular shape in parallel, the hysteresis is eliminated by using shape anisotropy. It is however difficult to completely eliminate the hysteresis, and the hysteresis occurs slightly. In addition, by narrowing the soft magnetic body as a sensor part, the shape anisotoropic magnetic field of the free layer increases, and it causes deterioration in sensitivity.

### SUMMARY OF THE INVENTION

The present invention has been achieved in consideration of such problems and an object of the invention is to provide a magnetic sensing device capable of suppressing occurrence of hysteresis to thereby reduce 1/f noise, stably sensing a signal magnetic field at high sensitivity, and holding the stability even when a strong external magnetic field that disturbs a free layer is applied, and a method of forming the same.

A first magnetic sensing device of the invention has a stacked body including: a pinned layer having a magnetization direction pinned in a predetermined direction; a free layer whose magnetization direction changes according to an external magnetic field and, when the external magnetic field is zero, becomes parallel to the magnetization direction of the pinned layer; and an intermediate layer sandwiched between the pinned layer and the free layer. The intermediate layer has a thickness at which an exchange bias magnetic field in the magnetization direction of the pinned layer becomes positive. The exchange bias magnetic field is generated between the pinned layer and the free layer. In this case, preferably, the intermediate layer has a thickness in a range from 2.1 nm to 2.5 nm. The meaning of “parallel” in the specification includes not only a state where the magnetization directions of the pinned layer and the free layer are the same, that is, the angle formed between the magnetization direction of the pinned layer and that of the free layer is strictly 0° C. but also a state where a gradient caused by an error occurring in manufacture, variations in properties, and the like occurs. “The exchange bias magnetic field is positive” means that the directions of spins in the free layer are the same by using the direction of the spin in the pinned layer as a reference. “The same direction” in this case corresponds to the case where the angle formed between the direction of the spin in the pinned layer and that of the spin in the free layer lies in a range equal to or larger than 0° and less than 90°.

A second magnetic sensing device of the invention has a stacked body including: a pinned layer having a magnetization direction pinned in a predetermined direction; a free layer whose magnetization direction changes according to an external magnetic field and, when the external magnetic field is zero, becomes anti-parallel to the magnetization direction of the pinned layer; and an intermediate layer sandwiched between the pinned layer and the free layer. The intermediate layer has a thickness at which an exchange bias magnetic field in the magnetization direction of the pinned layer becomes negative. The exchange bias magnetic field is generated between the pinned layer and the free layer. In this case, preferably, the intermediate layer has a thickness in a range from 1.9 nm to 2.0 nm. The meaning of “anti-parallel” in the specification includes not only a state where the magnetization directions of the pinned layer and the free layer are opposite to each other, that is, the angle formed between the magnetization direction of the pinned layer and that of the free layer is strictly 180° C. but also a state where a gradient caused by an error occurring in manufacture, variations in properties, and the like occurs. “The exchange bias magnetic field is negative” means that the directions of spins in the free layer are opposite when the direction of the spin in the pinned layer is used as a reference. “The opposite direction” in this case corresponds to the case where the angle formed between the direction of the spin in the pinned layer and that of the spin in the free layer lies in a range larger than 90° and equal to or smaller than 180°

In the first and second magnetic sensing devices of the invention constructed as described above, as compared with the case where the magnetization directions of the pinned layer and the free layer are orthogonal to each other when the external magnetic field is zero, variations in the directions of spins in the magnetic domains in the free layer are reduced. Consequently, when read current is passed in a state where the external magnetic field is applied in the direction orthogonal to the magnetization direction of the pinned layer, occurrence of hysteresis in the relation between a change in the external magnetic field and the resistance change is suppressed, and stability of the free layer also improves. In particular, in the case where the direction of the easy axis of magnetization of the free layer is parallel to the magnetization direction of the pinned layer, the directions of spins in the magnetic domains are easily aligned and hyseresis is reduced more.

In the first and second magnetic sensing devices of the invention, preferably, the intermediate layer is made of copper. Each of the first and second magnetic sensing devices may have bias applying means which applies a bias magnetic field to the free layer in a direction orthogonal to the magnetization direction of the pinned layer. In this case, the bias applying means can be either a permanent magnet or a bias current line extending in the magnetization direction of the pinned layer.

A method of forming the first magnetic sensing device includes: a stacking step of forming a stacked body by sequentially forming a first ferromagnetic layer whose magnetization direction changes according to an external magnetic field, an intermediate layer, and a second ferromagnetic layer having coercive force larger than that of the first ferromagnetic layer; and a regularization step of making a regularization so that the magnetization directions of the first and second ferromagnetic layers become parallel to each other. The intermediate layer is formed so as to have a thickness at which an exchange bias magnetic field in the magnetization direction of the second ferromagnetic layer becomes positive. The exchange bias magnetic field is generated between the first and second ferromagnetic layers, and setting of the magnetization directions of the first and second ferromagnetic layers in an initial state where the external magnetic field is zero is completed by the regularization step. The “initial state” denotes a state where the external magnetic field having a specific direction does not exist and a state which is a reference at the time of sensing the external magnetic field.

A method of forming the second magnetic sensing device includes: a stacking step of forming a stacked body by sequentially forming a first ferromagnetic layer whose magnetization direction changes according to an external magnetic field, an intermediate layer, and a second ferromagnetic layer having coercive force larger than that of the first ferromagnetic layer; and a regularization step of making a regularization so that the magnetization directions of the first and second ferromagnetic layers become anti-parallel to each other. The intermediate layer is formed so as to have a thickness at which an exchange bias magnetic field in the magnetization direction of the second ferromagnetic layer becomes negative. The exchange bias magnetic field generated between the first and second ferromagnetic layers, and setting of the magnetization directions of the first and second ferromagnetic layers in an initial state where the external magnetic field is zero is completed by the regularization step.

In the methods of forming the first and second magnetic sensing devices according to the invention, the setting of the magnetization directions of the first and second ferromagnetic layers in the initial state where the external magnetic field is zero is completed by the regularization step. Consequently, as compared with the case where the first and second ferromagnetic layers have the magnetization directions which are orthogonal to each other, variations in the directions of spins in the magnetic domains in the first ferromagnetic layer are reduced. Therefore, the magnetic sensing device is obtained such that when read current is passed in a state where the external magnetic field is applied in the direction orthogonal to the magnetization direction of the second ferromagnetic layer, occurrence of hysteresis in the relation between a change in the external magnetic field and the resistance change is suppressed and stability of the free layer improves.

In the method of forming the first magnetic sensing device of the invention, preferably, the intermediate layer is formed so as to have a thickness in a range from 2.1 nm to 2.5 nm by using copper. When the first ferromagnetic layer is formed so as to have an easy axis of magnetization, and the regularization is made so that the magnetization directions of the first and second ferromagnetic layers become parallel to the easy axis of magnetization, variations in the directions of spins are further reduced.

In the method of forming the first magnetic sensing device according to the invention, when the regularization is made by performing an annealing process while applying a magnetic field in the same direction as the direction of the easy axis of magnetization, for example, at a temperature in a range from 250° C. to 400° C. while applying a magnetic field in a range from 1.6 kA/m to 160 kA/m, occurrence of hysteresis is further suppressed.

In the method of forming the second magnetic sensing device according to the invention, preferably, the intermediate layer is formed so as to have a thickness in a range from 1.9 nm to 2.0 nm. When the first ferromagnetic layer is formed so as to have an easy axis of magnetization, and the regularization is made so that the magnetization direction of the second ferromagnetic layer becomes parallel to the easy axis of magnetization, and the magnetization direction of the first ferromagnetic layer becomes anti-parallel to the easy axis of magnetization, variations in the directions of spins are further reduced.

In the method of forming the second magnetic sensing device according to the invention, in the regularization step, an annealing process is performed while applying a magnetic field in the same direction as the direction of the easy axis of magnetization, an annealing process is performed while applying a magnetic field in the direction opposite to the direction of the easy axis of magnetization, and an annealing process is performed while applying a magnetic field in the same direction as the direction of the easy axis of magnetization. In such a manner, occurrence of hysteresis is further suppressed.

The first magnetic sensing device of the invention has a stacked body including: a pinned layer having a magnetization direction pinned in a predetermined direction; a free layer whose magnetization direction changes according to an external magnetic field and, when the external magnetic field is zero, becomes parallel to the magnetization direction of the pinned layer; and an intermediate layer sandwiched between the pinned layer and the free layer. The intermediate layer has a thickness at which an exchange bias magnetic field in the magnetization direction of the pinned layer becomes positive. The exchange bias magnetic field is generated between the pinned layer and the free layer. Therefore, in the case of passing read current in a state where the external magnetic field is applied in the direction orthogonal to the magnetization direction of the pinned layer, occurrence of hysteresis in the relation between a change in the external magnetic field and the resistance change can be suppressed, and stability of the free layer also improves. Moreover, different from the case of using shape anisotropy, deterioration in sensitivity does not occur. As a result, 1/f noise is suppressed and a signal magnetic field can be stably sensed at high sensitivity. In particular, the value of the magnetic field intensity can be measured accurately and continuously, so that the invention can be sufficiently applied not only to a digital sensor but also to an analog sensor. In particular, when the free layer has the easy axis of magnetization parallel to the magnetization direction of the pinned layer, variations in the directions of spins in the free layer can be reduced. As a result, sensitivity and stability can be further improved.

The second magnetic sensing device of the invention has a stacked body including: a pinned layer having a magnetization direction pinned in a predetermined direction; a free layer whose magnetization direction changes according to an external magnetic field and, when the external magnetic field is zero, becomes anti-parallel to the magnetization direction of the pinned layer; and an intermediate layer sandwiched between the pinned layer and the free layer. The intermediate layer has a thickness at which an exchange bias magnetic field in the magnetization direction of the pinned layer becomes negative, the exchange bias magnetic field is generated between the pinned layer and the free layer. Consequently, in the case of passing read current in a state where the external magnetic field is applied in the direction orthogonal to the magnetization direction of the pinned layer, effects similar to those of the first magnetic sensing device of the invention are obtained.

When each of the first and second magnetic sensing devices of the invention has bias applying means which applies a bias magnetic field to the free layer in a direction orthogonal to the magnetization direction of the pinned layer, by applying the bias magnetic field of proper intensity, the resistance change of the read current with respect to the external magnetic field can be made linear. In the case where the bias applying means takes the form of a bias current line extending in the magnetization direction of the pinned layer, by determining the direction of passing the bias current, the direction of the bias magnetic field is also determined.

The method of forming the first magnetic sensing device of the invention includes: a stacking step of forming a stacked body by sequentially forming a first ferromagnetic layer whose magnetization direction changes according to an external magnetic field, an intermediate layer, and a second ferromagnetic layer having coercive force larger than that of the first ferromagnetic layer; and a regularization step of making a regularization so that the magnetization directions of the first and second ferromagnetic layers become parallel to each other. The intermediate layer is formed so as to have a thickness at which an exchange bias magnetic field in the magnetization direction of the second ferromagnetic layer becomes positive, the exchange bias magnetic field is generated between the first and second ferromagnetic layers, and setting of the magnetization directions of the first and second ferromagnetic layers in an initial state where the external magnetic field is zero is completed by the regularization step. Consequently, the magnetic sensing device can be obtained in which, in the case of passing read current in a state where the external magnetic field is applied in the direction orthogonal to the magnetization direction of the pinned layer, occurrence of hysteresis in the relation between a change in the external magnetic field and the resistance change can be suppressed, and stability of the free layer also improves. Moreover, different from the case of using shape anisotropy, deterioration in sensitivity does not occur. In particular, by forming the first ferromagnetic layer so as to have the easy axis of magnetization, making the regularization by performing the annealing process while applying the magnetic field in the same direction as the direction of the easy axis of magnetization, and setting the magnetization directions of the first and second ferromagnetic layers to be parallel to the easy axis of magnetization, variations in the spin directions can be further reduced. As a result, 1/f noise is suppressed and a signal magnetic field can be stably sensed at high sensitivity. In this case, the value of the magnetic field intensity itself can be measured accurately and continuously, so that the invention can be sufficiently applied not only to a digital sensor but also to an analog sensor. In particular, when the free layer has the easy axis of magnetization parallel to the magnetization direction of the pinned layer, variations in the directions of spins in the free layer can be reduced. As a result, sensitivity and stability can be further improved.

The method of forming the second magnetic sensing device of the invention includes: a stacking step of forming a stacked body by sequentially forming a first ferromagnetic layer whose magnetization direction changes according to an external magnetic field, an intermediate layer, and a second ferromagnetic layer having coercive force larger than that of the first ferromagnetic layer; and a regularization step of making a regularization so that the magnetization directions of the first and second ferromagnetic layers become anti-parallel to each other. The intermediate layer is formed so as to have a thickness at which an exchange bias magnetic field in the magnetization direction of the second ferromagnetic layer becomes negative, the exchange bias magnetic field is generated between the first and second ferromagnetic layers, and setting of the magnetization directions of the first and second ferromagnetic layers in an initial state where the external magnetic field is zero is completed by the regularization step. Consequently, the magnetic sensing device can be obtained in which, in the case of passing read current in a state where the external magnetic field is applied in the direction orthogonal to the magnetization direction of the pinned layer, occurrence of hysteresis in the relation between a change in the external magnetic field and the resistance change can be suppressed, and stability of the free layer also improves. Moreover, different from the case of using shape anisotropy, deterioration in sensitivity does not occur. In particular, when the regularization is made by sequentially performing the first step of performing the annealing process while applying the magnetic field in the same direction as the direction of the easy axis of magnetization of the first ferromagnetic layer, the second step of performing the annealing process while applying the magnetic field in the direction opposite to the direction of the easy axis of magnetization, and the third step of performing the annealing process while applying the magnetic field in the same direction as that of the easy axis of magnetization, the magnetization direction of the second ferromagnetic layer is set to be parallel to the easy axis of magnetization, and the magnetization direction of the first ferromagnetic layer is set to be anti-parallel to the easy axis of magnetization, variations in the spin directions can be further reduced. Therefore, effects similar to those of the method of forming the first magnetic sensing device of the invention can be obtained.

Other and further objects, features and advantages of the invention will appear more fully from the following description.

### BRIEF DESCRIPTION OF THE DRAWINGS

FIGS. 1A to 1C are schematic diagrams showing the configuration of a magnetic sensing device according to a first embodiment of the invention.

FIG. 2 is an exploded perspective view showing a stacked body as a component of the magnetic sensing device illustrated in FIGS. 1A to 1C.

FIG. 3 is a conceptual diagram showing the relation between the thickness of an intermediate layer in the stacked body shown in FIG. 2 and the spin direction of a free layer.

FIG. 4 is a characteristic diagram showing the relation between the thickness of the intermediate layer in the stacked body shown in FIG. 2 and an exchange bias magnetic field.

FIG. 5 is a perspective view showing a detailed configuration of a part of the stacked body illustrated in FIG. 2.

FIG. 6 is a perspective view showing a more detailed configuration of the part of the stacked body illustrated in FIG. 2.

FIG. 7 is a perspective view showing a detailed configuration of another part of the stacked body illustrated in FIG. 2.

FIG. 8 is a conceptual diagram schematically showing a spin direction distribution in a free layer of the stacked body illustrated in FIG. 2.

FIG. 9 is a characteristic diagram showing magnetic field dependency of a resistance change rate in the magnetic sensing device illustrated in FIGS. 1A to 1C.

FIGS. 10A and 10B are conceptual diagrams showing a process of forming the magnetic sensing device illustrated in FIGS. 1A to 1C.

FIG. 11 is a schematic diagram showing the configuration of a magnetic sensing device according to a second embodiment of the invention.

FIG. 12 is a characteristic diagram showing magnetic field dependency of a resistance change rate in the magnetic sensing device illustrated in FIG. 11.

FIGS. 13A to 13D are conceptual diagrams showing a process of forming the magnetic sensing device illustrated in FIG. 11.

FIGS. 14A to 14F are characteristic diagrams showing the relation between characteristics and the thickness of an intermediate layer in the magnetic sensing device illustrated in FIGS. 1A to 1C.

FIGS. 15A to 15C are characteristic diagrams showing magnetic field dependency of a resistance change rate in the magnetic sensing device illustrated in FIGS. 1A to 1C.

FIGS. 16A to 16D are other characteristic diagrams showing magnetic field dependency of a resistance change rate in the magnetic sensing device illustrated in FIGS. 1A to 1C.

FIG. 17 is an exploded perspective view showing the configuration of a conventional stacked body having a spin valve structure.

FIG. 18 is a perspective view showing a detailed configuration of a part of the stacked body illustrated in FIG. 17.

FIG. 19 is a perspective view showing a more detailed configuration of a part of the stacked body illustrated in FIG. 17.

FIG. 20 is a perspective view showing a detailed configuration of another part of the stacked body illustrated in FIG. 17.

FIGS. 21A and 21B are diagrams for explaining the action of a general GMR effect.

FIGS. 22A to 22C are diagrams for explaining the operation of a thin film magnetic head in which the stacked body shown in FIG. 17 is mounted.

FIG. 23 is a characteristic diagram showing the relation between an external magnetic field (signal magnetic field) and electric resistance in the stacked body illustrated in FIG. 17.

FIGS. 24A to 24C are conceptual diagrams showing a process of forming the stacked body illustrated in FIG. 17.

FIG. 25 is a conceptual diagram schematically showing a spin direction distribution in the free layer of the stacked body illustrated in FIG. 17.

FIG. 26 is a characteristic diagram showing magnetic field dependency of resistance change in the stacked body illustrated in FIG. 17.

FIG. 27 is a characteristic diagram showing frequency dependency of noise which occurs in the stacked body illustrated in FIG. 17.

### DETAILED DESCRIPTION OF THE PRFERRED EMBODIMENTS

Embodiments of the invention will now be described in detail hereinbelow with reference to the drawings.

### First Embodiment

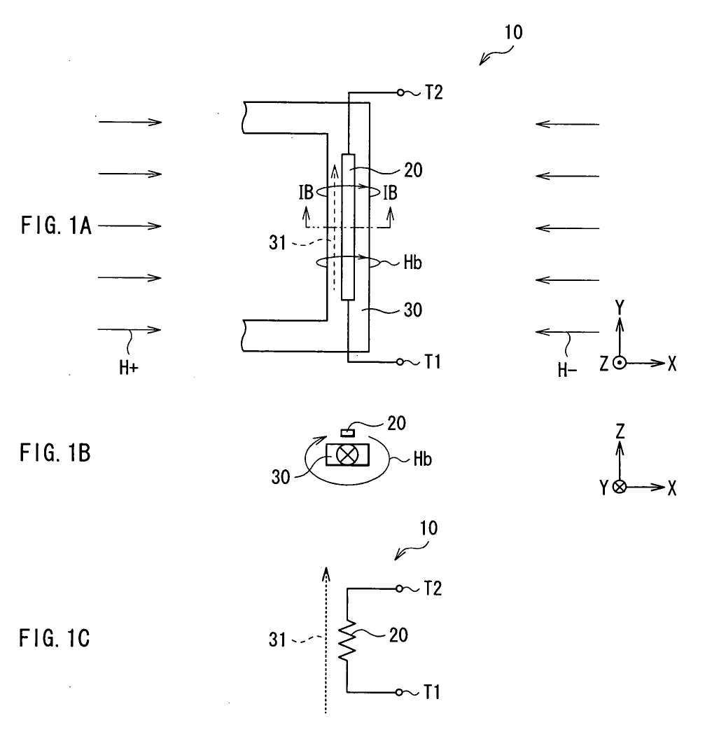

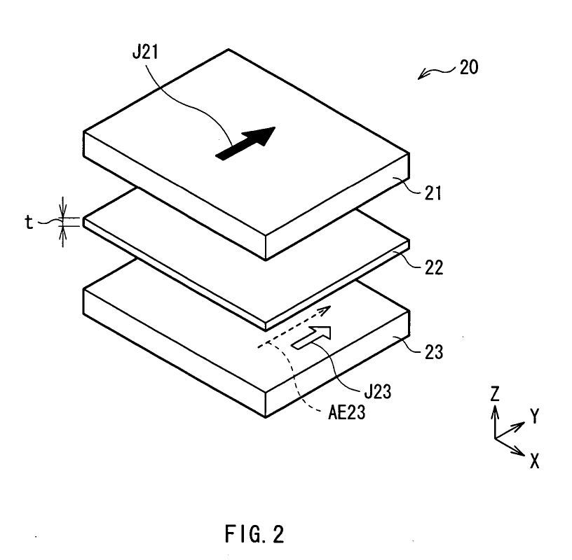

First, the configuration of a magnetic sensing device as a first embodiment of the invention will be described with reference to FIGS. 1A to 1C to FIG. 7.

FIGS. 1A to 1C show a schematic configuration of a magnetic sensing device 10 of the first embodiment. FIG. 1A is a plan view showing the configuration of the magnetic sensing device 10 and FIG. 1B shows a sectional configuration of the magnetic sensing device 10, taken along the line IB-IB of FIG. 1A. FIG. 1C shows an equivalent circuit corresponding to FIG. 1A. The magnetic sensing device 10 senses the presence/absence of a magnetic field in the environment of the magnetic sensing device 10 (external magnetic field) and the intensity of the magnetic field.

As shown in FIG. 1A, in the magnetic sensing device 10, a stacked body 20 and a bias current line 30 as bias applying means provided adjacent to the stacked body 20 are formed on a not-shown substrate. The stacked body 20 has a pinned layer whose magnetization direction is pinned in a predetermined direction (+Y direction in FIG. 1A) as will be described in detail later. The bias current line 30 is disposed so as to extend in the magnetization direction of the pinned layer near the stacked body 20 and bias current 31 flows. As shown in FIGS. 1A and 1B, the bias current 31 can be passed in the direction of the arrow (+Y direction around the stacked body 20) or the opposite direction (−Y direction around the stacked body 20). The bias current line 30 is electrically insulated from the stacked body 20. Separately from the bias current line 30, a lead wire is connected to the stacked body 20 and read current can be passed between terminals T1 and T2. In this case, the stacked body 20 can be regarded as a resistor, so that the magnetic sensing device 10 is an equivalent circuit as shown in FIG. 1C.

The stacked body 20 is obtained by stacking a plurality of functional films including a magnetic layer and, as shown in FIG. 2, includes a pinned layer 21 having a magnetization direction J21 pinned to a predetermined direction (for example, Y direction in FIG. 2), a free layer 23 having a magnetization direction J23 which changes according to the external magnetic field H, and an intermediate layer 22 sandwiched between the pinned layer 21 and the free layer 23 and having no specific magnetization direction. The intermediate layer 22 is made of copper (Cu) and whose top and under faces are in contact with the pinned layer and the free layer 23, respectively. The intermediate layer 22 can be made of a nonmagnetic metal having high conductivity such as copper or gold (Au). FIG. 2 shows an initial state where the external magnetic field H is zero (H=0) and the magnetization direction J23 is parallel to the magnetization direction J21. Each of the top face (the face on the side opposite to the intermediate layer 22) of the pinned layer 21 and the under face (the face on the side opposite to the intermediate layer 22) of the free layer 23 is protected with a not-shown protection layer.

An exchange bias magnetic field Hin in the magnetization direction J21 is generated between the pinned layer 21 and the free layer 23 (hereinbelow, simply called “exchange bias magnetic field Hin”), and the pinned layer 21 and the free layer 23 act each other via the intermediate layer 22. The intensity of the exchange bias magnetic field Hin changes with the spin direction of the free layer 23 in accordance with the interval between the pinned layer 21 and the free layer 23 (that is, the thickness “t” of the intermediate layer 22). In the embodiment, the intermediate layer 22 has the thickness “t” in a range in which the exchange bias magnetic field Hin becomes positive. The thickness “t” is desirably within the range from 2.1 nm to 2.5 nm. The thickness “t” exceeding 2.5 nm is not preferable because the resistance change rate sharply deteriorates. The stacked body 20 is a GMR element having the spin valve structure. When the external magnetic field H is applied, the relative angle between the magnetization direction J23 of the free layer 23 and the magnetization direction J21 of the pinned layer 21 changes. The relative angle varies according to the magnitude and direction of the external magnetic field H. Although FIG. 2 shows an example of the configuration in which the free layer 23, intermediate layer 22, and pinned layer 21 are stacked in order from the bottom, the invention is not limited to the configuration and the layers may be stacked in reverse order.

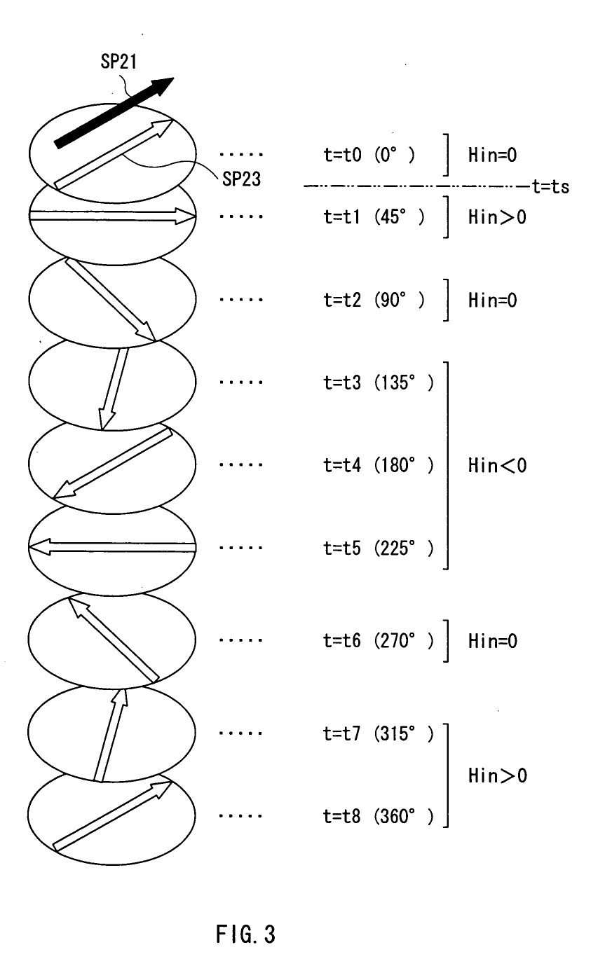

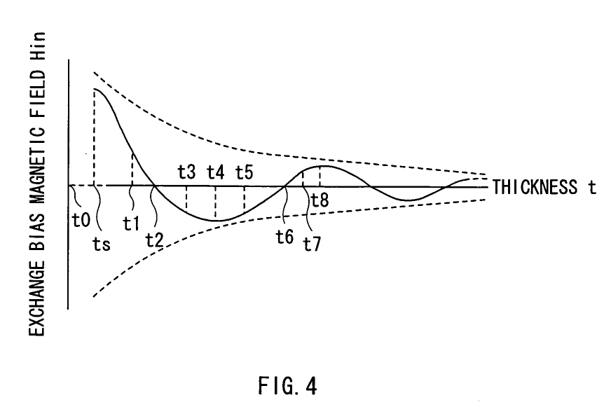

FIG. 3 shows the relation between the thickness “t” (horizontal axis) and the exchange bias magnetic field Hin (vertical axis). FIG. 4 schematically shows the relation between the thickness “t” and change in the spin direction SP23 of the free layer 23 with respect to the spin direction SP21 of the pinned layer 21. Reference numerals t0 to t8 in FIG. 4 correspond to those of FIG. 3.

As the thickness “t” increases, the exchange bias magnetic field Hin repeats increase and decrease and is gradually converged to zero (Hin=0). The thickness “t” of 0 (t=t0) corresponds to the state where the pinned layer 21 and the free layer 23 are in perfect contact with each other (state where the intermediate layer 22 does not exist). In this case, the pinned layer 21 and the free layer 23 are integrated, so that the spin directions SP21 and SP23 are the same, and the exchange bias magnetic field Hin is zero (Hin=0). When the pinned layer 21 and the free layer 23 are slightly apart from each other via the intermediate layer 22 and the thickness “t” of the intermediate layer 22 becomes thickness t1 (for example, about 0.1 to 1.0 nm) larger than a magnetic quantum size ts, the spin direction SP23 slightly turns and forms an angle of, for example, 45° with respect to the spin direction SP21. In this case, the exchange bias magnetic field Hin is positive (Hin>0). Further, when the thickness “t” increases like t2, t3, and t4 in order, the spin direction SP23 turns more, and the exchange bias magnetic field Hin gradually decreases. At the thickness t=t2 when the spin direction SP23 is orthogonal to the spin direction SP21, the exchange bias magnetic field Hin is zero (Hin=0). At the thickness t=t3 when the angle of, for example, 135° is formed with respect to the spin direction SP21, the exchange bias magnetic field Hin is negative (Hin<0). At the thickness t=t4 at which the exchange bias magnetic field Hin is the minimum value, the spin direction SP23 is stabilized in a state where it is inverted from the initial state.

Further, as the thickness t increases like t5, t6, t7, and t8 in order, the spin direction SP23 turns more, and the exchange bias magnetic field Hin gradually increases. At the thickness t=t6 when the spin direction SP23 is orthogonal to the spin direction SP21 (forms the angle of 270°), the exchange bias magnetic field Hin is zero (Hin=0). At the thickness t=t7 at which the angle of 315° is formed with respect to the spin direction SP21, the exchange bias magnetic field Hin is positive (Hin>0). At the thickness t=t8 at which the exchange bias magnetic field Hin is the maximum value, the spin direction SP23 becomes parallel to the spin direction SP21 and is stabilized. The present embodiment corresponds to this state.

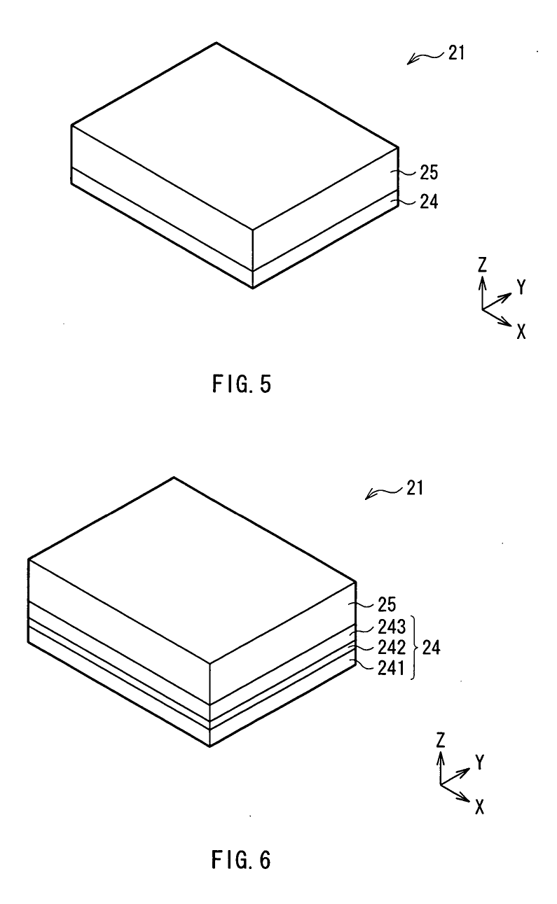

FIG. 5 shows a detailed configuration of the pinned layer 21. The pinned layer 21 has a configuration in which a magnetization pinned film 24 and an antiferromagnetic film 25 are stacked in order from the side of the intermediate layer 22. The magnetization pinned film 24 is made of a ferromagnetic material such as cobalt (Co), cobalt iron alloy (CoFe) or the like. The magnetization direction of the magnetization pinned layer 24 is the magnetization direction J21 of the pinned layer 21 as a whole. The antiferromagnetic film 25 is made of an antiferromagnetic material such as platinum manganese alloy (PtMn) or iridium manganese alloy (IrMn). The antiferromagnetic film 25 is in a state where the spin magnetic moment in a predetermined direction (for example, the +Y direction) and the spin magnetic moment in the opposite direction (for example, the −Y direction) completely cancel out each other, and functions so as to pin the magnetization direction J21 of the magnetization pinned film 24. A protection film 26 is made of a non-magnetic material which is chemically stable such as tantalum (Ta) or hafnium (Hf) and is to protect the magnetization pinned film 24, antiferromagnetic film 25, and the like.

The magnetization pinned film 24 may have a single layer structure or a configuration in which a first ferromagnetic film 241, an exchange coupling film 242, and a second ferromagnetic film 243 are stacked in order from the side of the intermediate layer 22 as shown in FIG. 6. The stacked body 20 including the pinned layer 21 and having the configuration of FIG. 6 is called a synthetic spin valve structure. The first and second ferromagnetic films 241 and 243 are made of a ferromagnetic material such as cobalt, CoFe or the like and the exchange coupling film 242 is made of a non-magnetic material such as ruthenium (Ru). In this case, the first and second ferromagnetic films 241 and 243 are exchange-coupled via the exchange coupling film 242 so that their magnetization directions become opposite to each other. Consequently, the magnetization direction of the magnetization pinned film 24 as a whole is stabilized. Further, a leakage magnetic field which leaks from the magnetization pinned film 24 to the free layer 23 can be weakened.

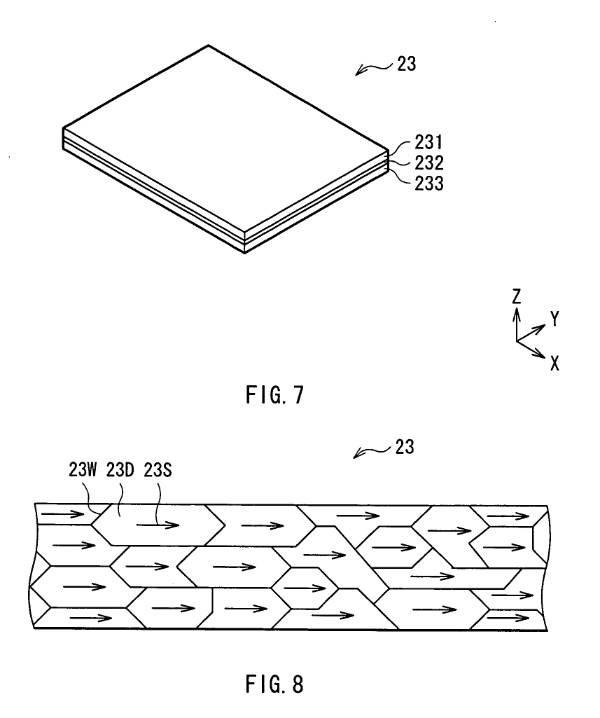

The free layer 23 may have a single-layer structure or a configuration in which two ferromagnetic thin films 231 and 233 are exchange-coupled to each other via an intermediate film 232 as shown in FIG. 7. In this case, the coercive force in the axis of hard magnetization of the free layer 23 can be further decreased.

The bias current line 30 is made of a metal material having high conductivity such as copper (Cu), gold (Au), or the like and functions so as to apply a bias magnetic field Hb to the stacked body 20.

The action of the magnetic sensing device 10 having the above configuration will now be described.

Different from the magnetization pinned film 24, the magnetization direction J23 of the free layer 23 turns according to the magnitude and direction of the external magnetic field H. The axis AE23 of easy magnetization of the free layer 23 is parallel to the magnetization direction J21 of the pinned layer 21. Therefore, in the stacked body 20, when the external magnetic field H is zero (that is, the initial state shown in FIG. 2), all of the axis AE23 of easy magnetization of the free layer 23 and the magnetization directions J23 and J21 are parallel to each other. Consequently, when the external magnetic field H is zero, the spin directions in the free layer 23 are easily aligned in a predetermined direction. FIG. 8 is a conceptual diagram schematically showing spin directions in magnetic domains in the free layer 23 in the case where the external magnetic field H is zero. As shown in FIG. 8, the free layer 23 has a plurality of magnetic domains 23D partitioned by magnetic domain walls 23W, and spins 23S are almost aligned in the same direction (magnetization direction J23).

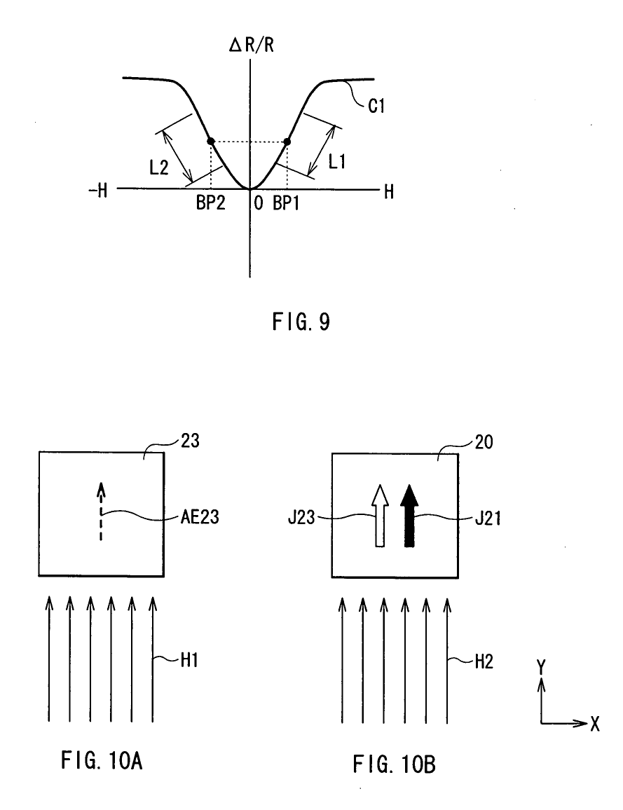

As described above, the stacked body 20 including the free layer 23 in which the spin directions are aligned hardly displays hysteresis when the external magnetic field H is applied in the direction orthogonal to the magnetization direction J21 (the magnetization direction J23). FIG. 9 shows the relation between the external magnetic field H and resistance change rate ΔR/R. The relation is expressed by an almost one curve C1 which is bilaterally symmetrical and shows the minimum value (ΔR/R=0) at the external magnetic field H=0. Consequently, when sensing (detection) of an external magnetic field in a direction orthogonal to the magnetization direction J21 is executed by using the magnetic sensing device 10, occurrence of hysteresis caused by inversion of the magnetization direction J23 of the free layer 23 is suppressed, and 1/f noise is reduced.

In the case of performing the sensing by using the magnetic sensing device 10 of the embodiment, as shown in FIGS. 1A and 1B, the bias magnetic field Hb is applied to the stacked body 20 by using the bias current line 30. Concretely, by passing the bias current 31 in, for example, the +Y direction to the bias current line 30, the bias magnetic field Hb in the +X direction is generated for the stacked body 20. Both of the magnetization directions J21 and J23 are set so as to be the +Y direction and are orthogonal to the bias magnetic field Hb. The reason why the bias magnetic field Hb is applied is because the curve C1 is non-linear around the external magnetic field H=0 as shown in FIG. 7. To detect a change in the external magnetic field H with high precision, it is desirable to use the characteristics of two linear zones L1 and L2 corresponding to inclined face portions on both sides of the curve C1. Therefore, it is necessary to apply the bias magnetic field Hb of the magnitude corresponding to a bias point BP1 or BP2 in an initial state. The bias points BP1 and BP2 are positioned in the center of the linear zones L1 and L2, respectively, and in positions indicative of the resistance change rates ΔR/R which are equal to each other.

For example, when the magnetic field H in the +X direction is defined as a positive field in FIG. 1A, it is preferable to pass the bias current 31 in the +Y direction to generate the bias magnetic field Hb (BP1) corresponding to the bias point BP1. When the external magnetic field H+in the positive direction (+X direction) is applied in this state, as obvious from the curve C1 of FIG. 9, the resistance change rate ΔR/R of the stacked body 20 becomes higher (than that in the initial state). On the contrary, when the external magnetic field H− in the negative direction (−X direction) is applied in the initial state where the bias magnetic field Hb (BP1) is applied, the resistance change rate ΔR/R of the stacked body 20 becomes lower (than that in the initial state). In the case where the bias magnetic field Hb (BP2) corresponding to the bias point BP2 is generated by passing the bias current 31 in the −Y direction, when the external magnetic field H+in the positive direction (+X direction) is applied, the resistance change rate ΔR/R becomes lower (than that in the initial state). When the external magnetic field H− in the negative direction (−X direction) is applied, the resistance change rate ΔR/R becomes higher (than that in the initial state). As described above, in any of the cases, the direction of the external magnetic field H can be known from the direction of change in the resistance change rate ΔR/R and, moreover, the magnitude of the external magnetic field H can be known from the magnitude of the change in the resistance change rate ΔR/R. Without the bias applying means, the sensing can be performed. However, when the linear zones L1 and L2 are used with the bias applying means, sensing can be performed with higher precision.

A method of forming the magnetic sensing device 10 will now be described in detail hereinbelow with reference to FIG. 2 and FIGS. 10A and 10B. FIGS. 10A and 10B are conceptual diagrams showing a simplified process of forming the magnetic sensing device 10.

In the method of forming the magnetic sensing device 10 of the embodiment, first, a first ferromagnetic layer (as the free layer 23) is formed on a not-shown substrate by sputtering or the like by using a soft magnetic material such as NiFe. At this time, the direction AE23 of the easy axis of magnetization is determined by forming the film while applying a magnetic field H1 in a predetermined position (for example, the +Y direction) (refer to FIG. 10A). The intermediate layer 22 is formed by using a non-magnetic metal material such as copper and a second ferromagnetic film (which will become the pinned layer 21) is formed by using a material having a coercive force larger than that of the first ferromagnetic film (stacking process). After that, a regularization is made so that the magnetization direction J23 of the first ferromagnetic layer and the magnetization direction J21 of the second ferromagnetic layer correspond to the direction AE23 of the easy axis of magnetization (a regularization process). Concretely, while applying the magnetic field H2 having intensity in a range from 1.6 kA/m to 160 kA/m in the same direction as the direction AE23 of the easy axis of magnetization, annealing process is performed at a temperature in a range from 250° C. to 400° C. (preferably 270° C.) for about four hours. By the process, the pinned layer 21 having the magnetization direction J21 pinned in a predetermined direction (+Y direction) is formed, and the free layer 23 having the direction AE23 of the easy axis of magnetization which is the same as the magnetization direction J21 and the magnetization direction J23 is formed. By the regularization process, setting of the magnetization directions J21 and J23 of the pinned layer 21 and the free layer 23 in the initial state where the external magnetic field H is zero is completed. In such a manner, formation of the stacked body 20 in which the free layer 23, intermediate layer 22, and pinned layer 21 are sequentially formed on the substrate is completed. After that, by performing predetermined processes such as a process of forming the bias current line 30 via an insulating layer and a process of connecting a lead wire for passing read current, the magnetic sensing device 10 is completed.

As described above, in the magnetic sensing device 10 and the method of forming the same of the embodiment, the stacked body 20 is provided which includes the pinned layer 21 having the magnetization direction J21 pinned to a predetermined direction (Y direction), the free layer 23 having the magnetization direction J23 which changes according to the external magnetic field H and is parallel to the magnetization direction J21 when the external magnetic field H is zero, and the intermediate layer 22 sandwiched between the pinned layer 21 and the free layer 23. Since the thickness “t” of the intermediate layer 22 is set so that the exchange bias magnetic field Hin becomes positive, the magnetization direction J23 is not inverted by the external magnetic field from a direction orthogonal to the magnetization direction J21. Thus, the magnetization directions J21 and J23 are stabilized. Therefore, in the case of passing read current in a state where the external magnetic field H is applied in the direction orthogonal to the magnetization direction J21 (magnetization direction J23), occurrence of hysteresis due to inversion of the magnetization direction J23 in the relation between the change in the external magnetic field H and the resistance change R can be suppressed. As a result, 1/f noise is suppressed and a signal magnetic field can be stably sensed at high sensitivity. In particular, the value of the magnetic field intensity can be measured accurately and continuously, so that the magnetic sensor is suitable as an analog sensor such as an ammeter.

### Second Embodiment

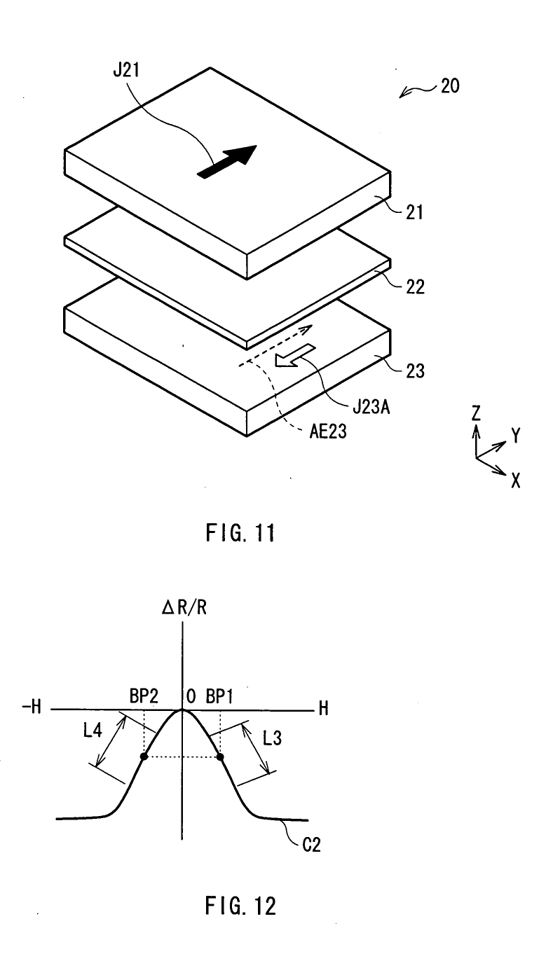

Referring now to FIG. 11, the magnetic sensing device 10 as a second embodiment will be described.

The magnetic sensing device 10 of the second embodiment has a configuration similar to that of the first embodiment except that the magnetization direction of the free layer 23 in the stacked body 20 is different from that of the first embodiment. Consequently, parts overlapping those in the first embodiment will not be described in the second embodiment.

The stacked body 20 of the second embodiment includes, as shown in FIG. 11, the free layer 23 having the magnetization direction J23A which is anti-parallel to the magnetization direction J21 of the pinned layer 21 in the initial state where the external magnetic field H is zero (H=0). The thickness “t” of the intermediate layer 22 is preferably in a range from 1.9 nm to 2.0 nm and, more preferably, 1.9 nm.

The exchange bias magnetic field Hin is generated between the pinned layer 21 and the free layer 23 and its intensity is negative. That is, this state corresponds to the state where the thickness “t” of the intermediate layer 22 is equal to t4 in FIGS. 3 and 4.

The stacked body 20 having such a configuration hardly displays hysteresis when the external magnetic field H is applied in the direction orthogonal to the magnetization direction J21 as shown in FIG. 12. FIG. 12 shows the relation between the external magnetic field H and resistance change rate ΔR/R. The relation is expressed by an almost one curve C2 which is bilaterally symmetrical and shows the maximum value (ΔR/R=0) at the external magnetic field H=0. Consequently, when sensing (detection) of an external magnetic field in a direction orthogonal to the magnetization direction J21 is executed by using the magnetic sensing device 10, occurrence of hysteresis caused by inversion of the magnetization direction J23A is suppressed, and 1/f noise is reduced.

In the case of performing the sensing by using the magnetic sensing device 10 of the second embodiment, in a manner similar to the first embodiment, as shown in FIGS. 1A and 1B, it is desirable to apply the bias magnetic field Hb to the stacked body 20 by using the bias current line 30 to detect a change in the external magnetic field H with high precision by using the characteristics of two linear zones L3 and L4 corresponding to inclined portions on both sides in the curve C2.

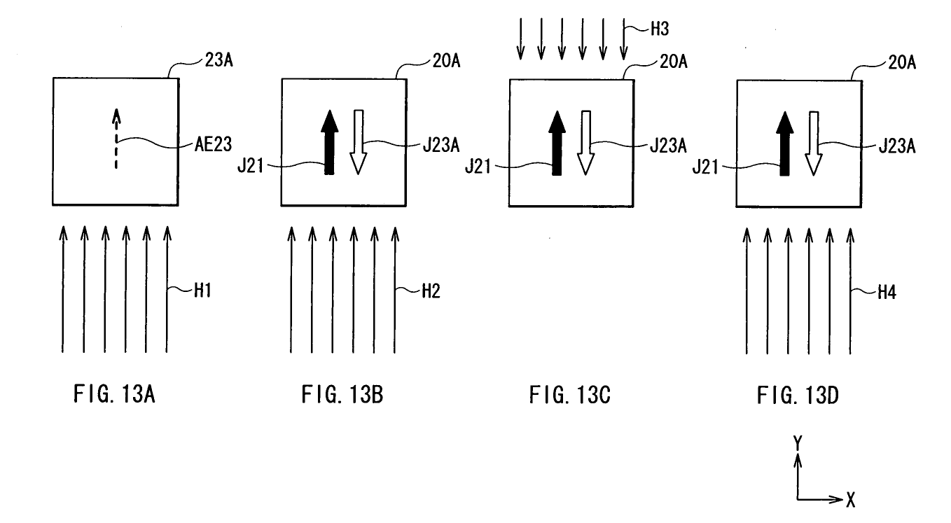

A method of forming the magnetic sensing device 10 will now be described in detail hereinbelow with reference to FIG. 11 and FIGS. 13A to 13D. FIGS. 13A to 13D are conceptual diagrams showing a simplified process of forming a magnetic sensing device 10.

In the method of forming the magnetic sensing device 10 of the embodiment, first, a first ferromagnetic layer as the free layer 23 is formed on a not-shown substrate. At this time, the direction AE23 of the easy axis of magnetization is determined by forming the film while applying a magnetic field H1 in a predetermined position (for example, the +Y direction) (refer to FIG. 13A). Next, the intermediate layer 22 is formed and a second ferromagnetic film which will become the pinned layer 21 is formed (stacking process). After that, a regularization is made so that the magnetization direction J21 of the second ferromagnetic layer is the same as the direction AE23 of the easy axis of magnetization and the magnetization direction J23A of the first ferromagnetic layer becomes the opposite to the direction AE23 (regularization process). Concretely, while applying the magnetic field H2 having intensity in a range from 1.6 kA/m to 160 kA/m in the same direction (+Y direction) as the direction AE23 of the easy axis of magnetization, annealing process is performed at a temperature in a range from 250° C. to 400° C. (preferably, 270° C.) for about four hours (first annealing process). Next, while applying a magnetic field H3 having intensity in a range from 1.6 kA/m to 160 kA/m in the direction (−Y direction) opposite to the direction AE23 of the easy axis of magnetization, annealing process is performed at a temperature in a range from 250° C. to 400° C. (preferably, 270° C.) for about one hour (second annealing process). Further, while applying a magnetic field H4 having intensity in a range from 1.6 kA/m to 160 kA/m in the same direction (+Y direction) as the direction AE23 of the easy axis of magnetization, annealing process is performed at a temperature in a range from 250° C. to 400° C. (preferably, 270° C.) for about one hour (third annealing process). By the processes, the pinned layer 21 having the magnetization direction J21 pinned in a predetermined direction (+Y direction) is formed, and the free layer 23 having the direction AE23 of the easy axis of magnetization which is opposite to the magnetization direction J21 is formed. As described above, the magnetization directions J21 and J23A are stabilized so as to be opposite to each other. That is, by the regularization process including the first to third annealing processes, setting of the magnetization directions J21 and J23A of the pinned layer 21 and the free layer 23 in the initial state where the external magnetic field H is zero is completed. In such a manner, formation of the stacked body 20 in which the free layer 23, intermediate layer 22, and pinned layer 21 are sequentially formed on the substrate is completed. After that, by performing predetermined processes similar to those of the first embodiment, the magnetic sensing device 10 is completed. Although the regularization can be performed to a certain degree without performing the second and third annealing processes, the regularization is promoted more by performing the first to third annealing processes as described above. Thus, occurrence of hysteresis can be further reduced.

As described above, in the magnetic sensing device 10 and the method of forming the same of the embodiment, the stacked body 20 is provided which includes the pinned layer 21 having the magnetization direction J21 pinned to a predetermined direction (Y direction), the free layer 23 having the magnetization direction J23A which changes according to the external magnetic field H and is anti-parallel to the magnetization direction J21 when the external magnetic field H is zero, and the intermediate layer 22 sandwiched between the pinned layer 21 and the free layer 23. Since the thickness “t” of the intermediate layer 22 is set so that the exchange bias magnetic field Hin becomes negative, the magnetization directions J21 and J23A are stabilized opposite to each other, and the magnetization direction J23A is not inverted by the external magnetic field from a direction orthogonal to the magnetization direction J21. Thus, the magnetization directions J21 and J23A are stabilized. Therefore, in the case of passing read current in a state where the external magnetic field H is applied in the direction orthogonal to the magnetization direction J21 (magnetization direction J23A), occurrence of hysteresis due to inversion of the magnetization direction J23A in the relation between the change in the external magnetic field H and the resistance change R can be suppressed. As a result, effects similar to those of the first embodiment can be obtained.

### EXAMPLE

An example of concrete numerical values of the magnetic sensing device 10 of the first embodiment will now be described.

In the example, the magnetic sensing device 10 having the stacked body 20 with the following configuration was formed on the basis of the magnetic sensing device forming method in the first and second embodiments. The stacked body 20 has the configuration of “0.3 of nickel iron alloy (NiFe), 1.0 of cobalt iron alloy (CoFe), copper (Cu), 2.5 of CoFe, 0.8 of ruthenium (Ru), 1.5 of CoFe, 15.0 of platinum manganese alloy (PtMn), and 3.0 of tantalum (Ta)”. “0.3 of NiFe and 1.0 of CoFe” corresponds to the free layer 23 having a bilayer structure. “Copper” corresponds to the intermediate layer 22. “2.5 of CoFe, 0.8 of Ru, 1.5 of CoFe” corresponds to the magnetization pinned film 24 having a three-layer structure. “15.0 of PtMn” corresponds to the antiferromagnetic film 25. “3.0 of tantalum” corresponds to he projection film. The numerical values indicated with the material names are thicknesses (nm) of the layers. In the example, by changing the thickness of the intermediate layer 22, either the magnetization direction J23 or J23A is selected in the free layer 23.

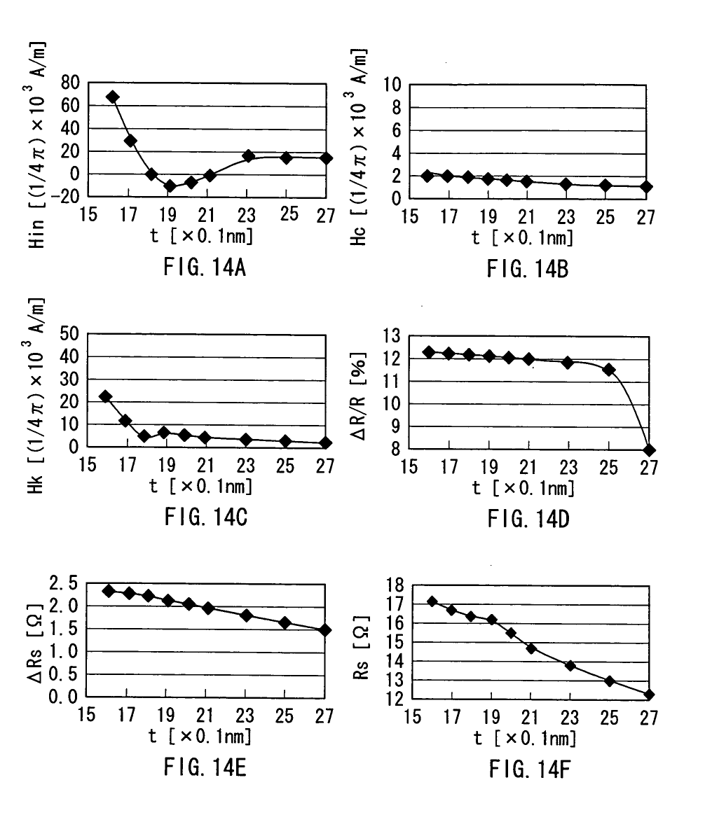

FIGS. 14A to 14F show dependency on the thickness “t” of the intermediate layer 22 of the characteristics of the stacked body 20. FIG. 14A shows a change in the exchange bias magnetic field (Hin) with the thickness “t”. As shown in FIG. 14A, the exchange bias magnetic field Hin gradually decreases from the thickness t=1.6 nm and is negative in the range of 1.80 nm<t<2.1 nm. After that, when the thickness “t” further increases, the exchange bias magnetic field Hin gently increases and becomes positive. Therefore, in the range where the thickness “t” is larger than 1.8 nm and less than 2.0 nm, the state corresponds to the second embodiment in which the free layer 23 expresses the magnetization direction J23A. In the range where the thickness “t” is equal to or larger than 2.1 nm, the state corresponds to the first embodiment in which the free layer 23 has the magnetization direction J23.

FIG. 14B shows a change in the coercive force Hc with respect to the thickness “t”. As shown in FIG. 14B, the coercive force Hc is 2×10³/(4π) [A/m] at the thickness t=1.6 nm and gradually decreases to the thickness t=2.6 nm.

FIG. 14C shows a change in an anisotropic magnetic field Hk with respect to the thickness “t”. As shown in FIG. 14C, the coercive force Hc decreases rather sharply from the thickness t=1.6 nm to t=1.8 nm and, after that, as the thickness t increases, decreases gently.

FIG. 14D shows a change in the resistance change rate ΔR/R with respect to the thickness “t”. As shown in FIG. 14D, the resistance change rate ΔR/R decreases gently in a zone of around 12% at the thickness t of 1.6 nm to 2.5 nm. At the thickness t=2.6, the resistance change rate ΔR/R decreases sharply and drops to 8%.

FIGS. 14E and 14F show changes in the resistance change amount (ΔRs) and sheet resistance (Rs) with respect to the thickness “t”, respectively. Both of them monotonously decrease at the thickness t=1.6 nm to 2.6 nm.

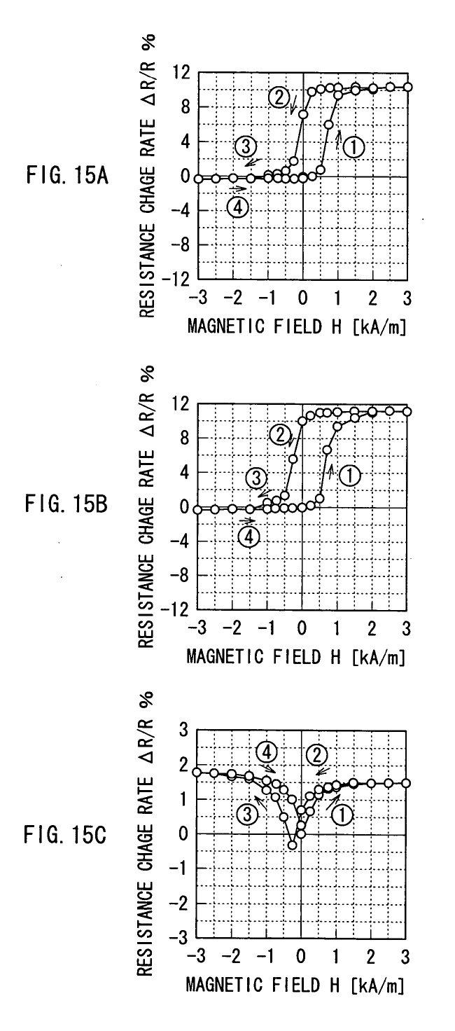

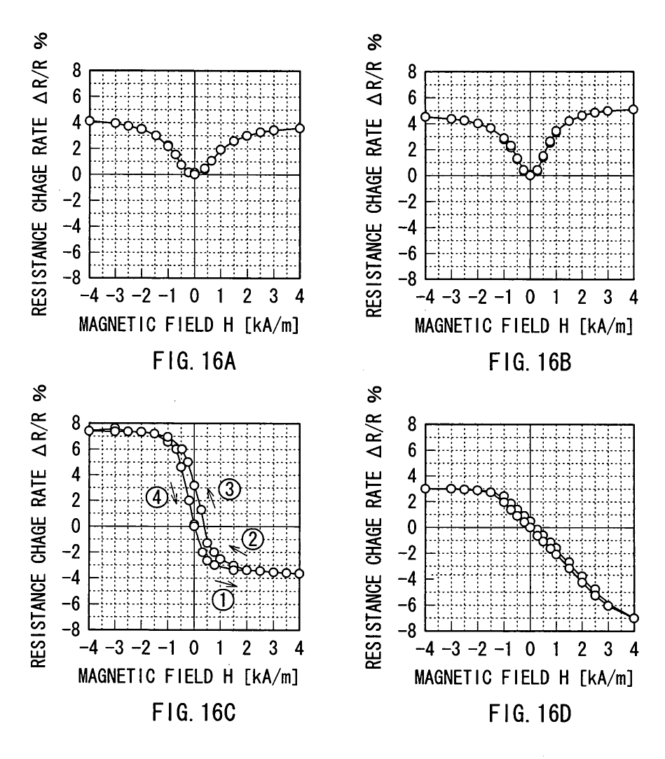

FIGS. 15A to 15C and FIGS. 16A to 16D show the result of examination of dependency on the magnetic field of the resistive change rate ΔR/R in the stacked body 20.

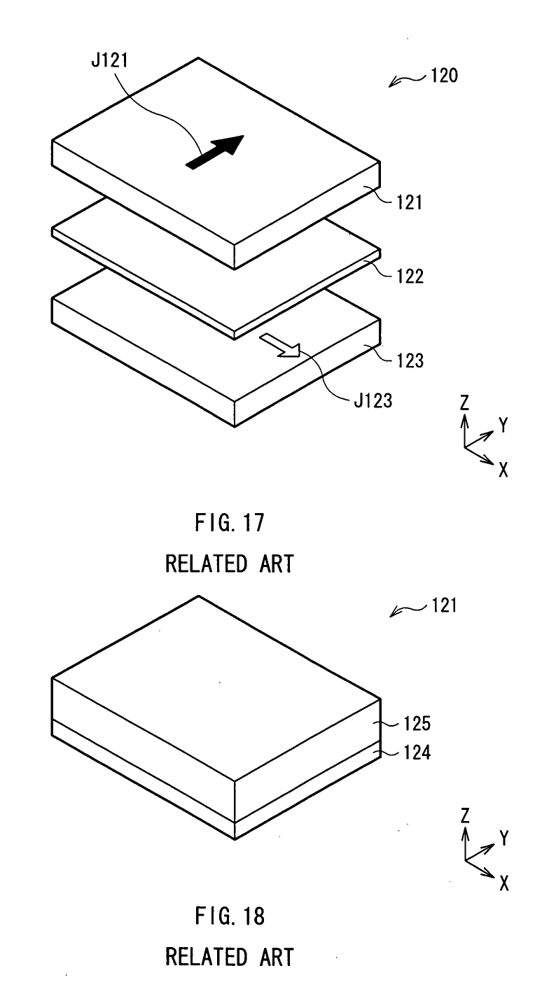

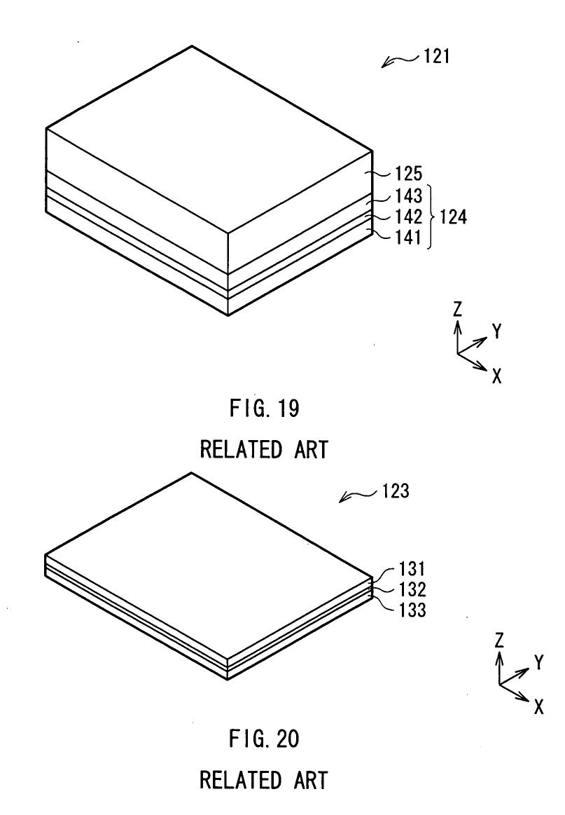

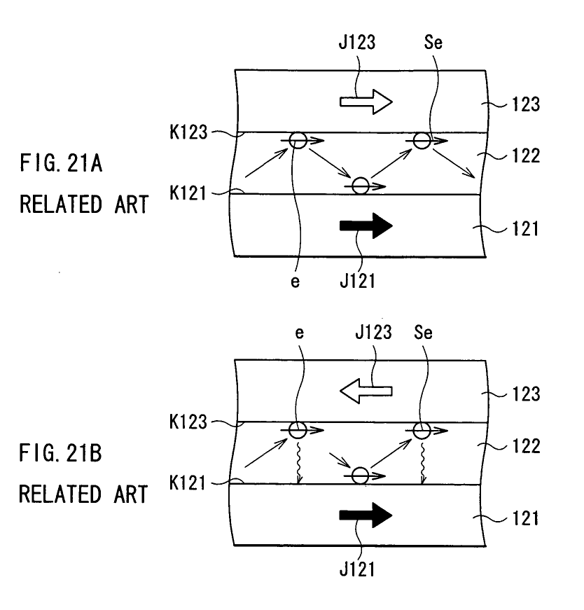

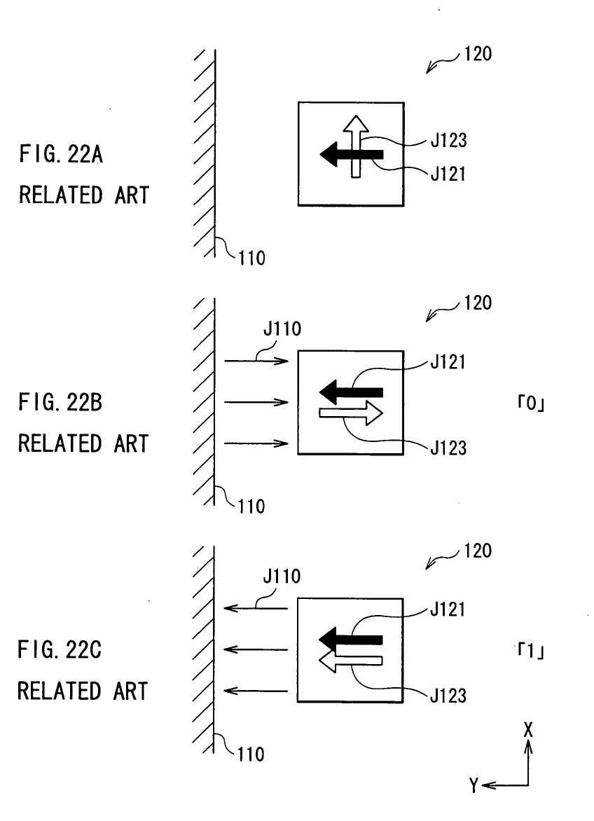

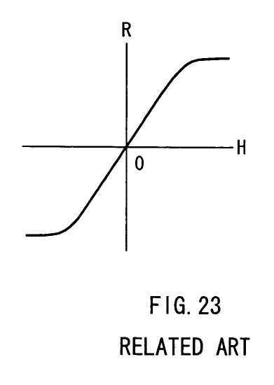

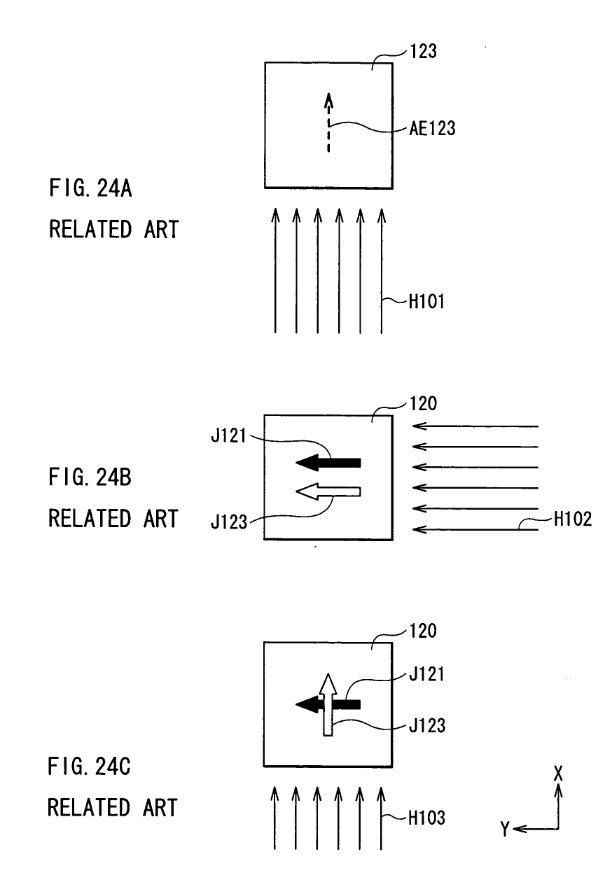

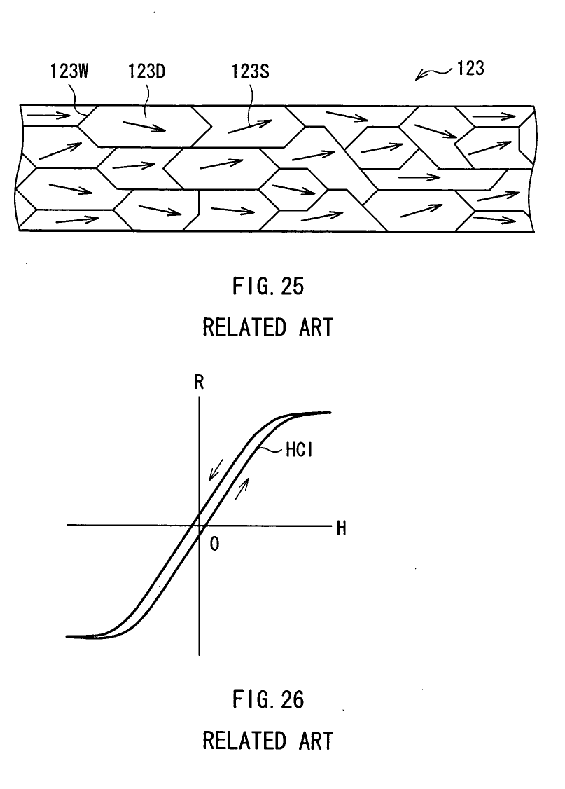

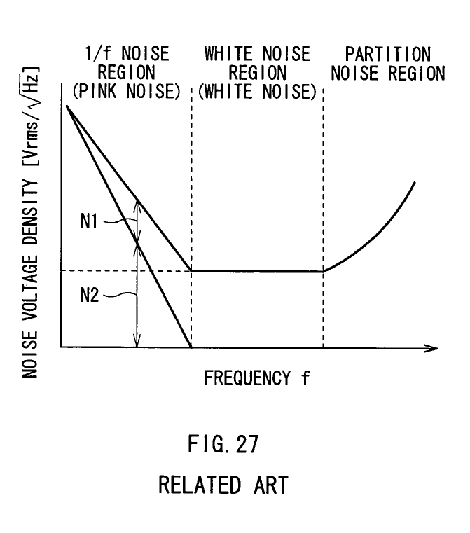

FIGS. 15A to 15C show changes in the resistance change rate ΔR/R of the case where the external magnetic field H is applied in the direction parallel with the magnetization direction J21 of the pinned layer 21 in the stacked body. In this case, the thickness “t” of the intermediate layer 22 is 1.5 nm, and the exchange bias magnetic field Hin between the pinned layer 21 and the free layer 23 is positive. FIG. 15A is a characteristic diagram of the stacked body 20 of a rectangular shape in plan view having a width of 2 μm and a length of 180 μm. FIG. 15B is a characteristic diagram of the stacked body 20 of a rectangular shape in plan view having a width of 18 μm and a length of 180 μm. FIG. 15C is a characteristic diagram of the conventional stacked body 120 shown in FIG. 17 when the external magnetic field H is applied in the direction orthogonal to the magnetization direction J121. The numbers (1) to (4) shown in FIGS. 15A to 15C indicate the directions of change.

As obvious from FIGS. 15A to 15C, the curve in the case where the external magnetic field H is applied to the positive side (the same direction as the magnetization direction J21) and that in the case where the external magnetic field H is applied to the negative side (the same direction as that magnetization direction J21) do not coincide with each other, and hysteresis appears.

On the other hand, FIGS. 16A to 16D show changes in the resistance change rate ΔR/R in the case where the external magnetic field H is applied in the direction orthogonal to the magnetization direction J21 of the pinned layer 21 in the stacked body 20. FIG. 16A is a characteristic diagram of the stacked body 20 of a rectangular shape in plan view having a width of 2 μm and a length of 180 μm in a manner similar to FIG. 15A. FIG. 16B is a characteristic diagram of the stacked body 20 of a rectangular shape in plan view having a width of 18 μm and a length of 180 μm in a manner similar to FIG. 15B. FIGS. 16C and 16D are characteristic diagrams of the conventional stacked body 120 shown in FIG. 17 when the external magnetic field H is applied in the direction orthogonal to the magnetization direction J121. FIG. 16C is a characteristic diagram of the stacked body 120 of a rectangular shape in plan view having a width of 18 μm and a length of 180 μm. The numbers (1) to (4) shown in FIG. 16C indicate the directions of change. FIG. 16D is a characteristic diagram of the stacked body 120 of a rectangular shape in plan view having a width of 2 μm and a length of 180 μm.

As obvious from FIGS. 16A and 16B, the stacked body 20 of the invention exhibits the excellent resistance change rate ΔR/R at which hysteresis hardly occurs. In particular, in the case where the width is set to 18 μm (FIG. 16B), higher sensitivity (tilt of the curve) as compared with the case where the width is set to 2 μm (FIG. 16A) is obtained. In contrast, in the conventional stacked body 120, by narrowing the width to 2 μm to increase the shape anisotoropy, occurrence of hysteresis is suppressed to a certain extent (FIG. 16D). However, the hysteresis could not be prevented and is slightly larger than that of the stacked body 20 of the invention shown in FIG. 16B.

As described above, in the example, the thickness of the intermediate layer 22 is set so that the exchange bias magnetic field Hin becomes positive, so that the magnetization directions J21 and J23 are stabilized in the same direction. It was recognized that, in a state where the external magnetic field H is applied in the direction orthogonal to the magnetization direction J21, occurrence of the hysteresis in the relation between a change in the external magnetic field H and the resistance change R (resistance change rate ΔR/R) can be suppressed.

Although the invention has been described above by some embodiments, the invention is not limited to the embodiments but may be variously modified. For example, although the case of sensing the analog signal magnetic field generated by the current flowing in a conductor has been described in the embodiments, the invention is not limited to the embodiments. The magnetic sensing device of the invention can be also applied for sensing a digital signal magnetic field of a high duty ratio like a magnetic encoder.

The magnetic sensing device of the invention can be used for the purpose of sensing a current value itself like an ammeter and also for an eddy current inspection technique of conducting a test for a defect in printing wiring or the like. In an application example, a line sensor in which a number of magnetic sensing devices are arranged on a straight line is formed and a change in eddy current is detected as a change in magnetic flux.

Obviously many modifications and variations of the present invention are possible in the light of the above teachings. It is therefore to be understood that within the scope of the appended claims, the invention may be practiced otherwise than as specifically described.

What is claimed is:

1. A magnetic sensing device having a stacked body comprising:
a pinned layer having a magnetization direction pinned in a predetermined direction;
a free layer whose magnetization direction changes according to an external magnetic field and, when the external magnetic field is zero, becomes parallel to the magnetization direction of the pinned layer; and
an intermediate layer sandwiched between the pinned layer and the free layer,
wherein the intermediate layer has a thickness at which an exchange bias magnetic field in the magnetization direction of the pinned layer becomes positive, the exchange bias magnetic field is generated between the pinned layer and the free layer.

2. A magnetic sensing device according to claim 1, wherein the intermediate layer has a thickness in a range from 2.1 nm to 2.5 nm.

3. A magnetic sensing device having a stacked body comprising:
a pinned layer having a magnetization direction pinned in a predetermined direction;
a free layer whose magnetization direction changes according to an external magnetic field and, when the external magnetic field is zero, becomes anti-parallel to the magnetization direction of the pinned layer; and
an intermediate layer sandwiched between the pinned layer and the free layer,
wherein the intermediate layer has a thickness at which an exchange bias magnetic field in the magnetization direction of the pinned layer becomes negative, the exchange bias magnetic field is generated between the pinned layer and the free layer.

4. A magnetic sensing device according to claim 3, wherein the intermediate layer has a thickness in a range from 1.9 nm to 2.0 nm.

5. A magnetic sensing device according to claims 1, wherein the intermediate layer is made of copper.

6. A magnetic sensing device according to claims 1, wherein the free layer has an easy axis of magnetization parallel to the magnetization direction of the pinned layer.

7. A magnetic sensing device according to claims 1, further comprising bias applying means which applies a bias magnetic field to the stacked body in a direction orthogonal to the magnetization direction of the pinned layer.

8. A magnetic sensing device according to claim 7, wherein the bias applying means is either a permanent magnet or a bias current line extending in the magnetization direction of the pinned layer.

9. A magnetic sensing device according to claims 3, wherein the intermediate layer is made of copper.

10. A magnetic sensing device according to claims 3, wherein the free layer has an easy axis of magnetization parallel to the magnetization direction of the pinned layer.

11. A magnetic sensing device according to claims 3, further comprising bias applying means which applies a bias magnetic field to the stacked body in a direction orthogonal to the magnetization direction of the pinned layer.

12. A magnetic sensing device according to claim 11, wherein the bias applying means is either a permanent magnet or a bias current line extending in the magnetization direction of the pinned layer.

13. A method of forming a magnetic sensing device, comprising:
a stacking step of forming a stacked body by sequentially forming a first ferromagnetic layer whose magnetization direction changes according to an external magnetic field, an intermediate layer, and a second ferromagnetic layer having coercive force larger than that of the first ferromagnetic layer; and
a regularization step of making a regularization so that the magnetization directions of the first and second ferromagnetic layers become parallel to each other,
wherein the intermediate layer is formed so as to have a thickness at which an exchange bias magnetic field in the magnetization direction of the second ferromagnetic layer becomes positive, the exchange bias magnetic field is generated between the first and second ferromagnetic layers, and
setting of the magnetization directions of the first and second ferromagnetic layers in an initial state where the external magnetic field is zero is completed by the regularization step.

14. A method of forming a magnetic sensing device according to claim 13, wherein the intermediate layer is formed so as to have a thickness in a range from 2.1 nm to 2.5 nm.

15. A method of forming a magnetic sensing device according to claim 13, wherein the first ferromagnetic layer is formed so as to have an easy axis of magnetization, and
the regularization is made so that the magnetization directions of the first and second ferromagnetic layers become parallel to the easy axis of magnetization.

16. A method of forming a magnetic sensing device according to claim 15, wherein the direction of the easy axis of magnetization is set by forming the first ferromagnetic layer while applying a magnetic field in a predetermined direction.

17. A method of forming a magnetic sensing device according to claim 15, wherein the regularization is made by performing an annealing process while applying a magnetic field in the same direction as the direction of the easy axis of magnetization.

18. A method of forming a magnetic sensing device according to claim 17, wherein the annealing process is performed at a temperature in a range from 250° C. to 400° C. while applying a magnetic field in a range from 1.6 kA/m to 160 kA/m.

19. A method of forming a magnetic sensing device, comprising:
a stacking step of forming a stacked body by sequentially forming a first ferromagnetic layer whose magnetization direction changes according to an external magnetic field, an intermediate layer, and a second ferromagnetic layer having coercive force larger than that of the first ferromagnetic layer; and
a regularization step of making a regularization so that the magnetization directions of the first and second ferromagnetic layers become anti-parallel to each other,
wherein the intermediate layer is formed so as to have a thickness at which an exchange bias magnetic field in the magnetization direction of the second ferromagnetic layer becomes negative, the exchange bias magnetic field is generated between the first and second ferromagnetic layers, and
setting of the magnetization directions of the first and second ferromagnetic layers in an initial state where the external magnetic field is zero is completed by the regularization step.

20. A method of forming a magnetic sensing device according to claim 19, wherein the intermediate layer is formed so as to have a thickness in a range from 1.9 nm to 2.0 nm.

21. A method of forming a magnetic sensing device according to claim 19, wherein the first ferromagnetic layer is formed so as to have an easy axis of magnetization, and
the regularization is made so that the magnetization direction of the second ferromagnetic layer becomes parallel to the easy axis of magnetization, and the magnetization direction of the first ferromagnetic layer becomes anti-parallel to the easy axis of magnetization.

22. A method of forming a magnetic sensing device according to claim 21, wherein the direction of the easy axis of magnetization is set by forming the first ferromagnetic layer while applying a magnetic field in a predetermined direction.

23. A method of forming a magnetic sensing device according to claim 21, wherein in the regularization step, the regularization is made by sequentially performing:
a first step of performing an annealing process while applying a magnetic field in the same direction as the direction of the easy axis of magnetization;
a second step of performing an annealing process while applying a magnetic field in the direction opposite to the direction of the easy axis of magnetization; and
a third step of performing an annealing process while applying a magnetic field in the same direction as the direction of the easy axis of magnetization.

24. A method of forming a magnetic sensing device according to claim 23, wherein the annealing process is performed at a temperature in a range from 250° C. to 400° C. while applying a magnetic field in a range from 1.6 kA/m to 160 kA/m in the first to third steps.

25. A method of forming a magnetic sensing device according to claim 13, wherein the intermediate layer is formed by using copper.

26. A method of forming a magnetic sensing device according to claim 19, wherein the intermediate layer is formed by using copper.
